(19) United States
(12) Patent Application Publication
(10) Pub. No.: US 2009/0233060 A1
(43) Pub. Date: Sep. 17, 2009

(54) Camouflage and similar patterns and techniques for creating such patterns

(76) Inventor: Philip Duke, Columbus, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/381,736

(22) Filed: Mar. 16, 2009

Related U.S. Application Data
(60) Provisional application No. 61/069,515, filed on Mar. 14, 2008.

(51) Int. Cl. B32B 3/10; B05D 1/36

(52) U.S. Cl. 428/195.1; 427/258

(57) ABSTRACT

Camouflage and other patterns and techniques for creating and using such patterns are disclosed. Many of the disclosed patterns and pattern-creation techniques avoid creating the “black blob” effect that renders many existing camouflage patterns ineffective at a distance. Certain disclosed patterns have elements that cause the patterns to look non-distinct up close, but to appear more defined when viewed at a distance. Clothing, guns, vehicles, and other articles having such a pattern may better blend with the surrounding environment both close up and when viewed at a distance. An exemplary pattern comprises single-color shapes sized and/or having other characteristics such that, when viewed from a distance, the single-color shapes form groupings that appear to be larger distinct shapes rather than a blobbed together single color or uniform pattern. When viewed from a distance, for example, a camouflage pattern may look like a combination of leaves, trees, rocks, or natural elements.

### RELATED APPLICATIONS

This document claims the benefit of U.S. Provisional Application Ser. No. 61/069,515, entitled “Camouflage and Similar Patterns and Techniques for Creating Such Patterns” and filed Mar. 14, 2008, the entire contents of which are incorporated by this reference.

### FIELD

Embodiments disclosed herein relate generally to articles of manufacture having camouflage and similar patterns, and to techniques for creating such patterns.

### BACKGROUND

Camouflage patterns have a variety of uses including those related to hunting and recreational sports and those related to military and tactical concealment. Such patterns are used on many types of hard good items and other articles of manufacture. The earliest camouflage was likely a simple application of mud or other natural substance to a person's body, clothing, or other item to be camouflaged. Colored uniforms have also been used for centuries. For example, dirt-colored uniforms were used to camouflage soldiers in desert environments at least as early as the late 1800s. In addition, early custom camouflage used at least as early as World War I included patterns and shapes found in nature.

With recent advances in fabric and printing technologies, photo-realistic camouflage has become common. Many camouflage patterns when viewed at short distances match an environment almost exactly. However, such patterns, including those that rely on ultra-realistic images, tend to visually “close up” when viewed from a distance, such as when viewed from 20 yards away, creating a “black blob” effect. Such patterns tend to fade when viewed at 10 yards or more. Generally as distance increases, the patterns tend to appear more monotone and less natural, often defeating the functionality of the camouflage by betraying the shape of the camouflaged object. Even many of the more modern, digitally-designed camouflage patterns tend to appear monotone or consistently peppered and unnatural.

### SUMMARY

Camouflage and other patterns and techniques for creating and using such patterns are disclosed. In addition to providing patterns that can provide camouflage functionality, many of the pattern-creation techniques can be used to enhance a pattern's appearance generally and/or provide other visual effects. With respect to camouflage, many of the disclosed patterns and pattern-creation techniques avoid creating the “black blob” effect that renders many existing camouflage patterns ineffective at a distance. Certain patterns have elements that cause the patterns to look non-distinct up close, but to appear more defined when viewed at a distance. Clothing, guns, vehicles, and other articles having such a pattern may better blend with the surrounding environment both close up and when viewed at a distance. An exemplary pattern comprises single-color shapes (which may also be called “pixels”) sized and/or having other characteristics such that, when viewed from a distance, the single-color shapes form groupings that appear to be larger distinct shapes rather than a blobbed together single color or uniform pattern. Such larger shapes can portray natural elements and/or abstract elements. When viewed from a distance, for example, a camouflage pattern may look like a combination of leaves, trees, rocks, etc.

The single-color shapes may be square, rectangular, circular, round, organically-shaped or have any other shape. The size, shape, and/or color of the single-color shapes are selected to allow the portrayed elements to be visible from greater distances, which is sometimes described as “projecting” to greater distances. Limiting the number of colors in a pattern can also facilitate projecting the portrayed elements to farther distances. Using a limited number of colors and appropriately sized single-color shapes can help ensure that details of a pattern will not visually blend together when viewed at a distance. A projecting pattern can be created in many ways. For example, a pattern creation process may involve using one or more base images of natural elements and adjusting color and/or pixel characteristics so that the portrayed natural elements are distinguishable from one another at a distance.

These illustrative embodiments are mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the certain embodiments are better understood when the following Detailed Description is read with reference to the accompanying drawings, wherein:

FIGS. 1A and 1B illustrate a digital camouflage pattern according to one embodiment;

FIGS. 2A and 2B illustrate applying color and pixel effects according to another embodiment;

FIG. 3 provides a larger view of the image of FIG. 1A;

FIG. 4 illustrates the contents of an electronic document including original artwork for use in an exemplary embodiment creating a camouflage pattern;

FIG. 5 illustrates scaling the contents of the electronic document in the exemplary embodiment creating a camouflage pattern begun in FIG. 4;

FIG. 6 illustrates a custom tile feature of an existing software application that is used to create and configure single-color shapes in the exemplary embodiment creating a camouflage pattern begun in FIG. 4;

FIGS. 7A-C illustrate the creation of exemplary single-color shapes in the exemplary embodiment creating a camouflage pattern begun in FIG. 4;

FIGS. 8A-C illustrate scaling the image up to form a scaled up image in the exemplary embodiment creating a camouflage pattern begun in FIG. 4;

FIG. 9 illustrates a pattern that will be used as a background to the larger shapes of the pattern 80 in the exemplary embodiment creating a camouflage pattern begun in FIG. 4;

FIG. 10 illustrates the camouflage pattern created by the exemplary embodiment creating a camouflage pattern begun in FIG. 4;

FIG. 11 illustrates four abutting instances of the camouflage pattern of FIG. 10; and

FIGS. 12A-B illustrate another exemplary pattern according to certain embodiments.

### DETAILED DESCRIPTION

Elements can be used to form camouflage and other patterns that cause the patterns to look non-distinct up close, but to appear more defined when viewed at a distance. An exemplary pattern comprises single-color shapes that, when viewed from a distance, form groupings that appear to be larger shapes rather than blob together as a single color or uniform pattern. Such larger shapes can portray natural elements and/or abstract elements. When viewed from a distance, for example, a camouflage pattern may look like a combination of leaves, trees, rocks, etc. The size, shape, and/or color of the single-color shapes are selected to allow the portrayed elements to be identifiable at greater distances or to “project” to greater distances. Limiting the number of colors in a pattern can also facilitate projecting the portrayed elements to farther distances. Using a limited number of colors and appropriately sized single-color shapes can help ensure that details of a pattern will not visually blend together when viewed at a distance.

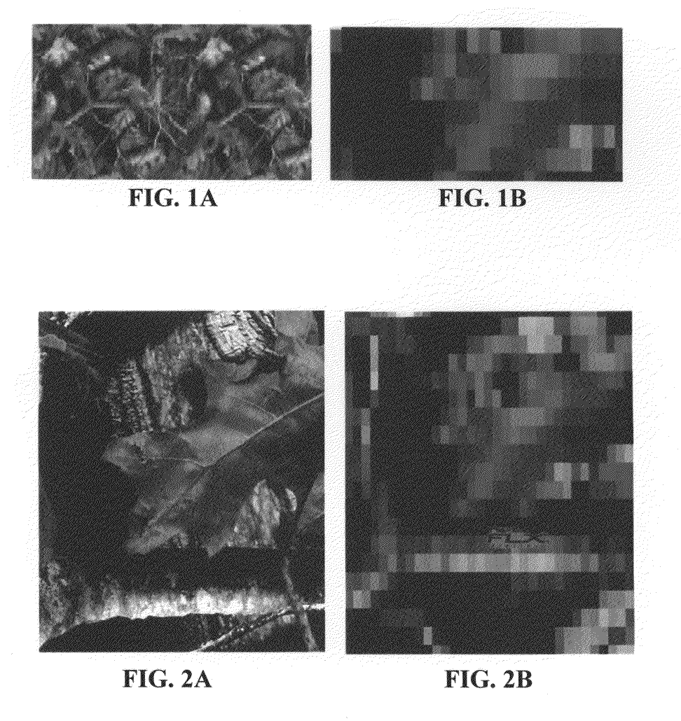

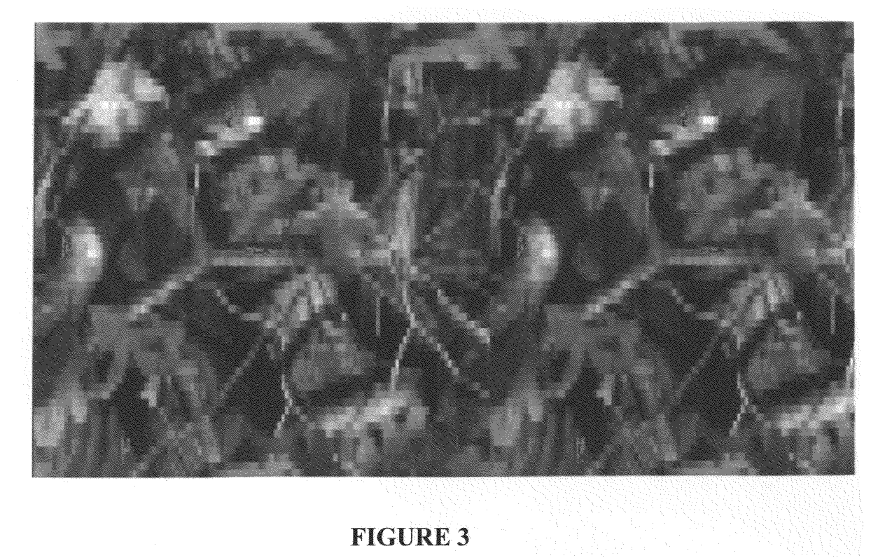

FIGS. 1A and 1B illustrate a digital camouflage pattern according to one embodiment. FIG. 1B illustrates a view of a portion of the pattern shown in FIG. 1A from close range, revealing the individual pixels of that portion of the pattern. When viewed from a distance the elements of the pattern are distinguishable from one another. FIG. 3 provides a larger view of the image of FIG. 1A.

FIGS. 2A and 2B illustrate applying color and pixel effects according to another embodiment. The image of FIG. 2A is modified by reducing the number of colors and creating rectangular pixels as shown in FIG. 2B in accordance with certain of the techniques discussed herein.

Certain embodiments provide articles of manufacture patterned with single-color shapes and larger shapes formed by groupings of the single-color shapes. The single-color shapes that make up a larger shape may be configured (e.g., sized, shaped, etc.) to facilitate the larger shape appearing distinct when viewed at a distance. The larger shape may also be partially or fully bordered by colors of sufficient color difference to facilitate the larger shape appearing distinct when viewed at a distance. The larger elements of the pattern may mimic natural elements to facilitate camouflaging the article when it is used in a natural environment that includes similar natural elements. Such a pattern may look like a blurred mosaic of the natural elements when viewed at a distance of less than 3 yards, while the natural elements may appear distinct when viewed at a distance of 10 yards. In such cases, the pattern as a whole will not appear to have single color or repeating pattern such that the single color or repeating pattern betrays the outline of the article when the article is used in a natural environment that includes similar natural elements.

A shape is “distinct” for purposes of evaluating a pattern if the shape can be distinguished from its surroundings at a given distance. Depending on the pattern characteristics, the larger shapes of the pattern may appear distinct at 10 yards, 30 yards, 50 yards, 100 yards, or even further. Unless otherwise specified, determining whether a shape appears distinct at a given distance should be done in conditions similar to those in which the pattern will be used. For example, outdoor hunting camouflage can be tested in typical outdoor hunting conditions to determine whether shapes of the pattern appear distinct or all blob together (i.e., blob out) at a given distance. Patterns may also better satisfy established criteria for evaluating camouflage, including but not limited to, criteria established by NATO. Camouflage provided for use in accordance with such criteria, i.e., for that specific use, can be assessed in conditions specified by NATO criteria to determine whether shapes appear distinct or not at a given distance.

Generally, in some embodiments, at least some of the larger shapes will portray natural elements. A larger shape portraying a natural element may include fewer colors than the natural element that is portrayed by the larger shape. For example, the larger shape may be an image of a leaf modified to have fewer colors than the actual leaf in the original photograph or other image of the leaf. Thus, a larger shape portraying a natural element may have been derived from a portion of a photograph or other image of the natural element. In some cases, the number of colors in a larger shape may be reduced to 10 colors, 5 colors, 4 colors, 3 colors, 2 colors, or even to a single color. The colors of a shape or of the pattern as a whole may all be neutral colors.

Exemplary natural elements include, but are not limited to leaves, flowers, tree branches, tree trunks, and other tree and plant portions. Exemplary articles of manufacture having surfaces upon which a pattern may be used include, but are not limited to jackets, shirts, pants, hats, socks, bandanas, guns, crossbows, tents, vehicles, aircrafts, watercrafts, and buildings.

Certain embodiments provide a method of creating patterns that produce the effect of enhanced resolution of a pattern when viewed from a distance. The pattern may be designed in a repeatable format. In one embodiment, one or more photographs are used. Original elements may be photographed in one or more natural settings for use in creation of the final pattern. Such elements may be color-corrected and digitally extracted from original files to create a base artwork, for example in Adobe® Photoshop® computer software. The base artwork may be scaled down, for example by 50 percent horizontally, so that pixels created at a latter stage can be given an elongated shape. The artwork may be flattened and exported, for example in an Adobe® Photoshop® format to another application to make color adjustments and create pixels. The number of colors in the base artwork may be reduced from millions down to a smaller number, as examples, less than 50, less than, 40, less than 30, or less than 20. For example, the number of colors may be reduced from millions to 12 to 15 colors.

A tiling or other effect can be applied to create pixels, for example squares, circles, or other shapes, that scatter the pattern into a mosaic-like design. The size of the pixels may be constant or may vary within a pattern. The size of the pixels will generally be sufficiently large to ensure that enhanced resolution when viewed from a distance is achieved. Any suitable techniques for generating a limited number of colors and/or a pixilated-appearance may be used. Accordingly, the above steps may be performed by any suitable technique, for example Corel® Painter® computer software may be used, and a resulting file may be exported to Adobe® Photoshop® or another suitable application for final scaling. If the artwork was previously scaled down, the image may be scaled back up, for example horizontally by a factor of 150 percent, and exported for final use, for example in TIFF format for engraving rotor development or other use.

Certain embodiments provide methods of providing a camouflage pattern on an article of manufacture. One exemplary method comprises creating the pattern by positioning larger shapes portraying natural elements in a pattern area and modifying the appearance of the larger shapes to appear as groupings of single-color shapes. The single-color shapes are configured (e.g., sized, shaped, etc.) such that when the pattern is used on an article of manufacture at least some of the one or more larger shapes will appear distinct when viewed at a distance of 10 yards. For example, configuring the single-color shapes such that when the pattern is used on the article at least some of the one or more larger shapes will appear distinct when viewed at a distance of 10 yards may be accomplished by a pattern designer viewing the pattern displayed on a computing device from a distance and making a determination of whether to adjust the size or shape of single-color shapes. Once the camouflage pattern is created, it is provided for use on the article of manufacture. For example, the pattern may be printed or incorporated in a shirt that will be worn in a natural environment in which the camouflage pattern camouflages the shirt and its wearer. The camouflage pattern can be repeated on the article. For example, a first instance of the pattern may abut a second instance of the pattern. At the boundary of the two instances one or more of the larger shapes may match or align to further enhance the appearance of the article.

This exemplary method may involve creating the pattern by positioning larger shapes on different layers of an electronic document comprising the camouflage pattern, using a background layer of the different layers of the document to provide a portion of the pattern that will appear less distinct than at least some of the larger shapes, and/or combining the different layers of the document into a single layer prior to modifying the appearance of the larger shapes.

The exemplary method may involve creating elongated single-color shapes. For example, the method may involve modifying one or more dimensions of the camouflage pattern prior to modifying the appearance of the larger shapes and restoring the dimension of the pattern after modifying the appearance of the larger shapes. Restoring the dimensions results in changing the single-color shapes to vertically-elongated single-color shapes.

Single-color shapes may be configured to have a brick, hexagon, square, triangle, or organically-shaped shape. The single-color shapes may have boundaries such that the shape can be said to be square, rectangular, circular, organic, or other shape. The shape of the single-color shapes may vary among the single-color shapes. The number of colors in the camouflage pattern may be reduced for an engraving used to provide the pattern on the article of manufacture. The scale of the pattern can be such that the larger shapes portraying natural elements are approximately equal in size to the natural elements that are portrayed. Alternatively, the scale may not match, for example, the scale of the pattern can be such that the larger shapes portraying natural elements are between 5% and 15% larger in size than the natural elements portrayed by the larger shapes.

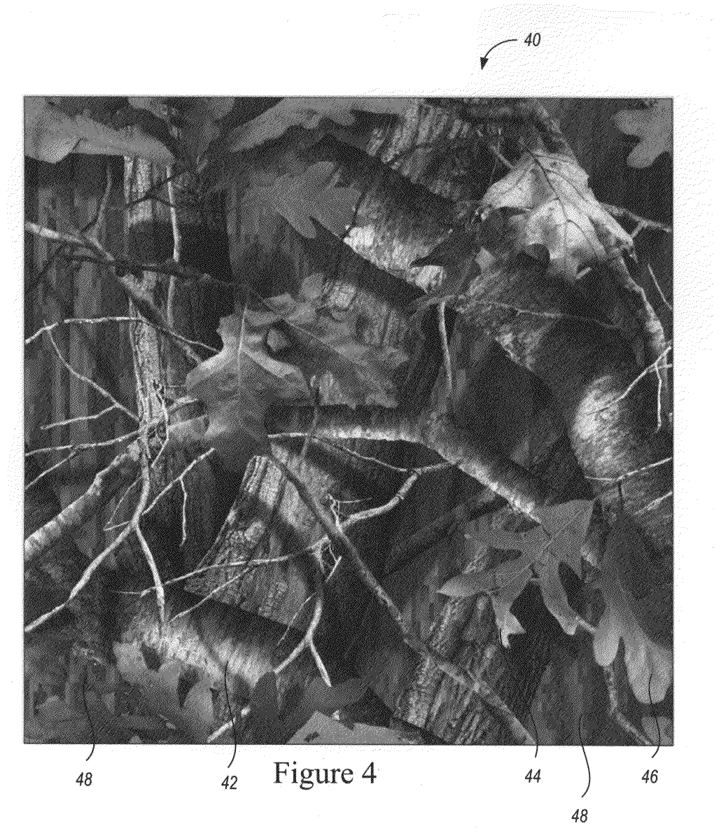

FIGS. 4-11 are used to illustrate the creation of a camouflage pattern 40 according to certain embodiments. FIG. 4 illustrates the contents of an electronic document including original artwork for use in an exemplary embodiment creating a camouflage pattern. Such content may be created, for example, using the Adobe® Photoshop® software application. For example, a document of original artwork may be a photograph of a natural setting. As another example, multiple photographs of natural elements may be combined into a single piece of content. The different natural elements may be used in a layered file—for example, every branch and leaf, may be placed on a separate layer. Multiple layers may then be combined together. In FIG. 4, various natural elements, such as branch 42 and leaves 44, 46, were placed on the original artwork 40. A background layer 48 is shown to illustrate how the pattern will appear with a background.

A piece of original artwork can be based on any type of source image. The artwork could be, but is not limited to being, computer generated, created by hand, scanned, and/or derived from an existing image or other electronic content. For example, a logo, face profile, or 3-dimensional movie could provide some or all of a piece of original artwork. Digital photography may be used to provide one or more original elements from a variety of natural settings for use in creation of the artwork. Elements can be color-corrected, digitally extracted from original files and composed in an original fashion to create the base artwork.

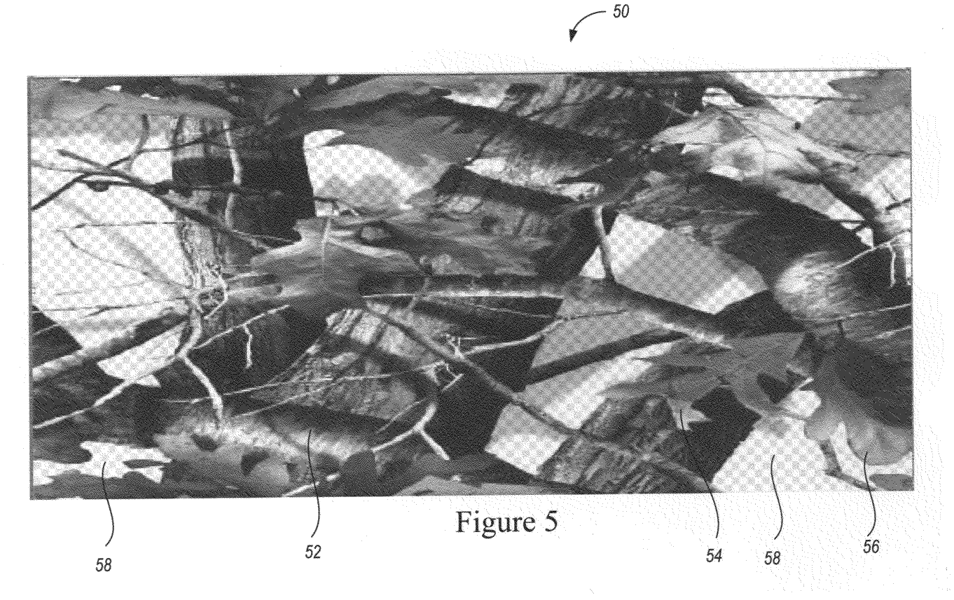

FIG. 5 illustrates scaling the contents of the electronic document in the exemplary embodiment creating a camouflage pattern begun in FIG. 4. Image 50 appears as a squished down version of the camouflage pattern 40. Working with a squished image will ultimately result in elongated pixels after the image is pixilated and returned to its normal dimensions. As one example, the original artwork can be scaled down horizontally by 50 percent to create vertically elongated pixels at a later stage. Also, the background 48 of FIG. 4 has been removed and replaced with a checkerboard portion, which will ultimately result in the background area appearing more pixilated (and therefore deeper and less pronounced) than the natural elements, including branch 52 and leaves 54, 56.

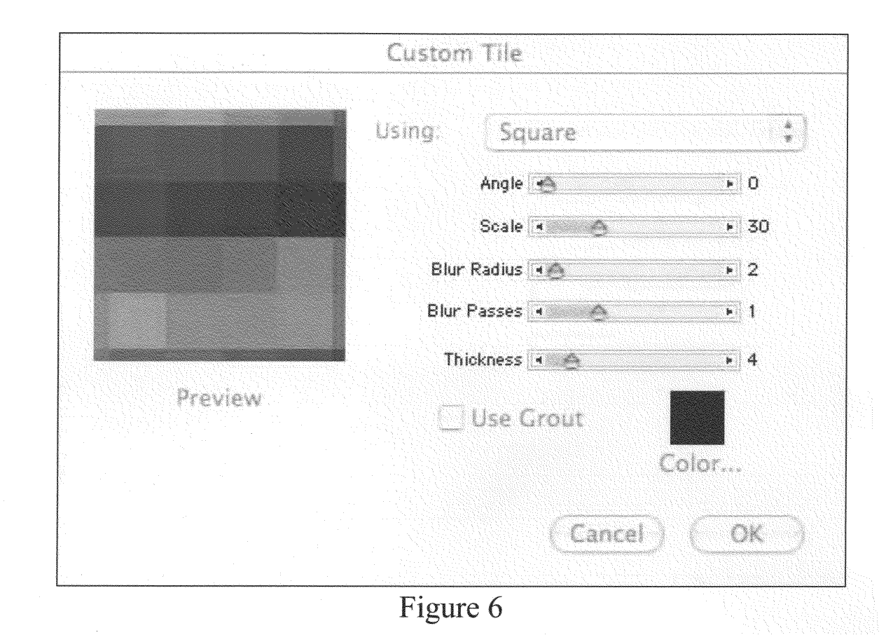

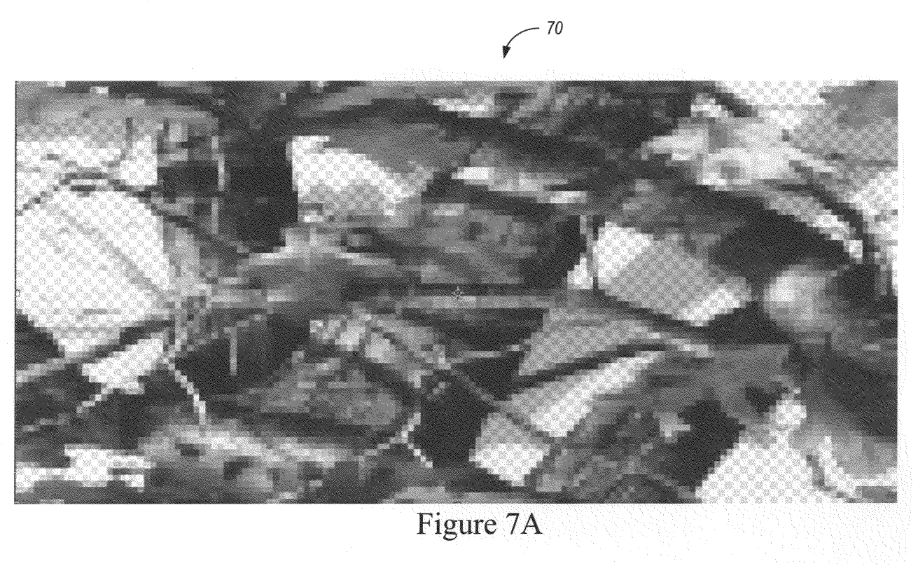

FIG. 6 illustrates a custom tile feature of an existing software application that is used to create and configure single-color shapes in the exemplary embodiment creating a camouflage pattern begun in FIG. 4. Corel® Painter® provides such an interface and corresponding custom tiling feature. To create the pattern, in this exemplary method, the settings are adjusted to create single-color shapes having appropriate characteristics. For example, the angle, scale, blur radius, blur passes, and thickness and shape (e.g., brick, hexagon, square, triangle, cross, etc.) settings may be adjusted and may differ based on the image used. Applying a custom tile or other effect may expressly or implicitly reduce the number of colors in the image. The number of colors may be reduced from millions, for example, down to 12 to 15 colors or even fewer colors.

Moreover, in addition to this specific example, which is provided for illustration only, it will be understood that single-color shapes can be created in a variety of other manual and automated ways. For example, a “woodcut” effect feature could be applied to an electronic image.

Configuring the single-color shapes may involve testing several configurations on a computer screen to identify which settings are most effective. For example, a designer may back away from a computer screen to visualize how the setting changes the way shapes interact with one another visually. Once a good candidate for the settings is identified, it can be tested on an actual article such as a shirt to confirm its appearance on computer assessment. Scale (or size) of the single-color shapes is of particular importance since it is a significant factor with respect to how distinctly shapes appear when viewed at a distance.

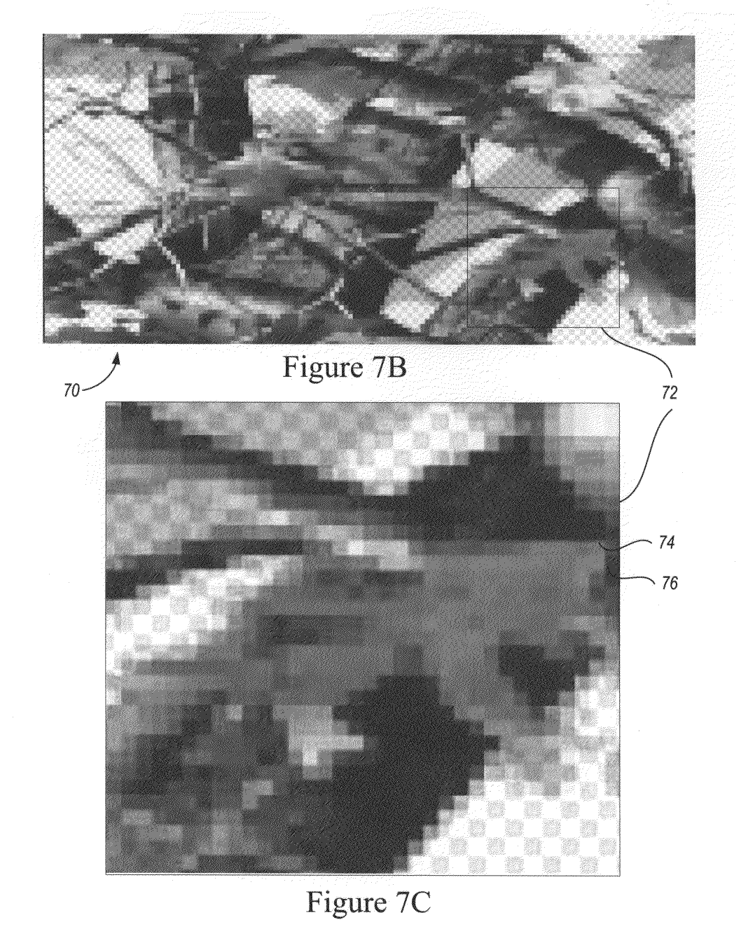

FIGS. 7A-C illustrate the creation of exemplary single-color shapes in the camouflage pattern 70. In this case, a custom tiling effect was applied using squares to scatter the pattern into a “mosaic” like design. FIGS. 7B and 7C illustrate a close up of a portion 72 of the pattern 70. This close up is presented to illustrate the mosaic like design by illustrating single color shapes, such as those numbered 74 and 76.

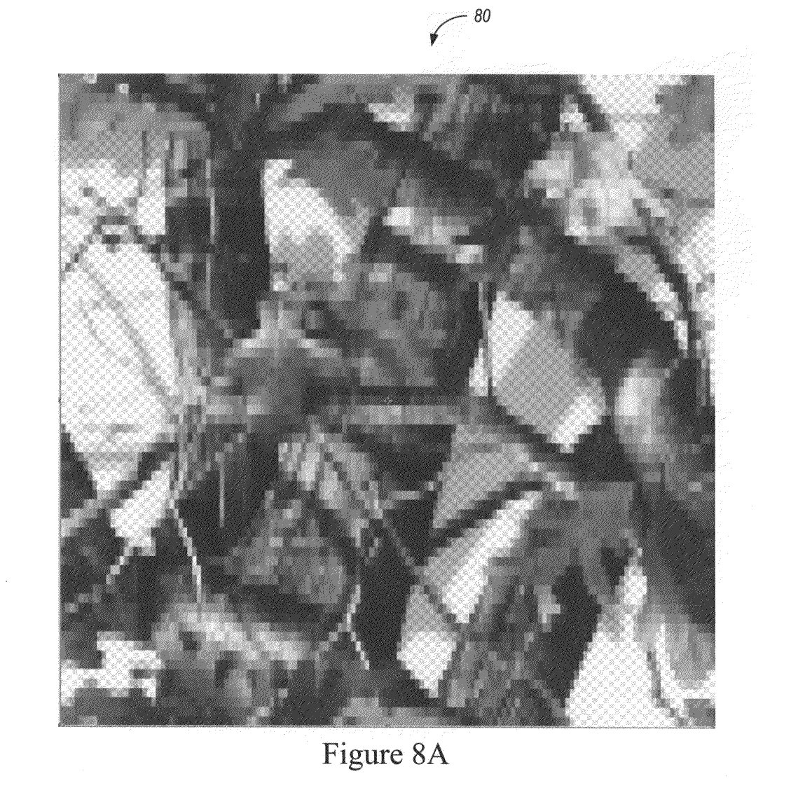

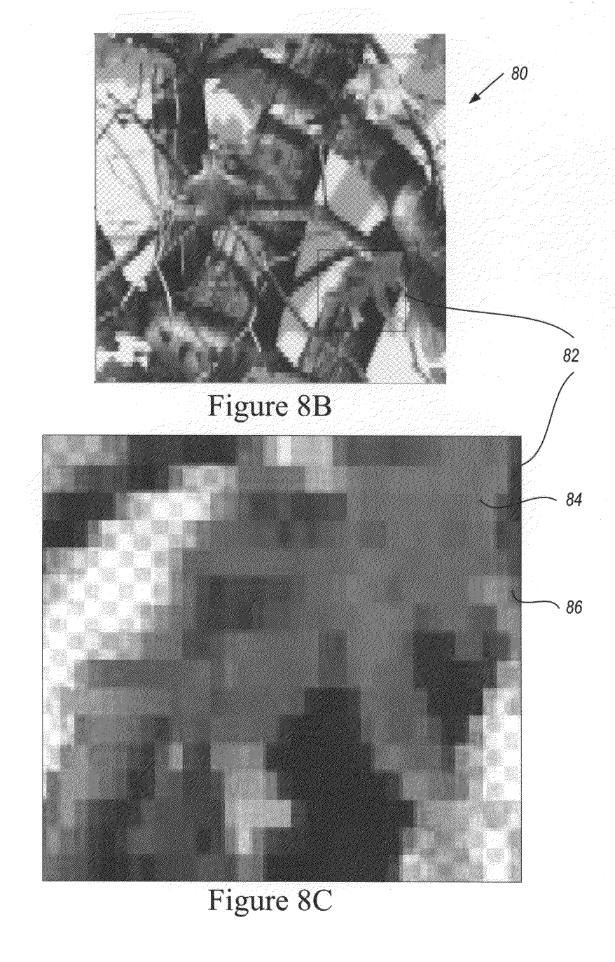

FIGS. 8A-C illustrate scaling the image 70 up to form a scaled up image 80 in the exemplary embodiment creating a camouflage pattern begun in FIG. 4. For example, the image 70 can be scaled up horizontally by a factor of 150 or 200 percent. FIGS. 8B and 78 illustrate a close up of a portion 82 of the pattern 80. This close up is presented to illustrate elongated single-color shapes of the pattern 80, such as those numbered 74 and 76.

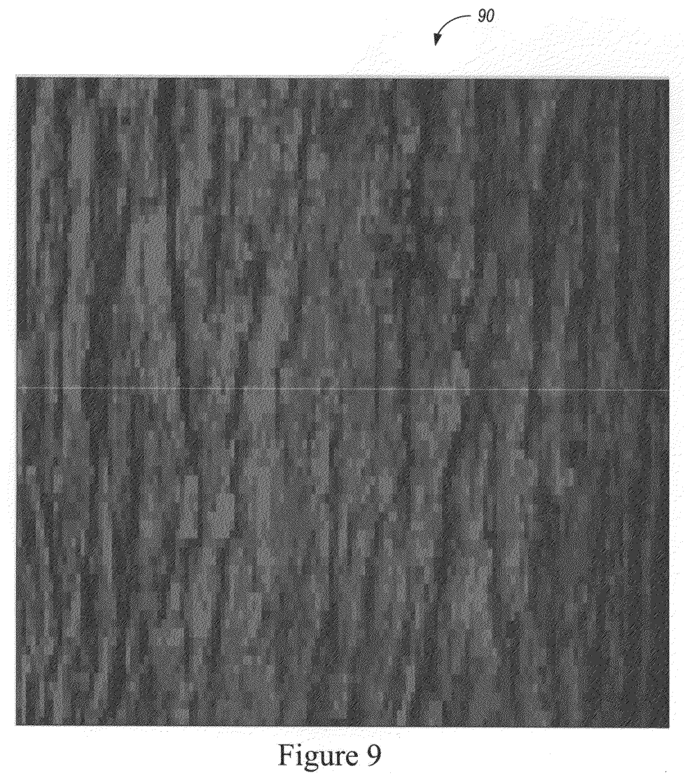

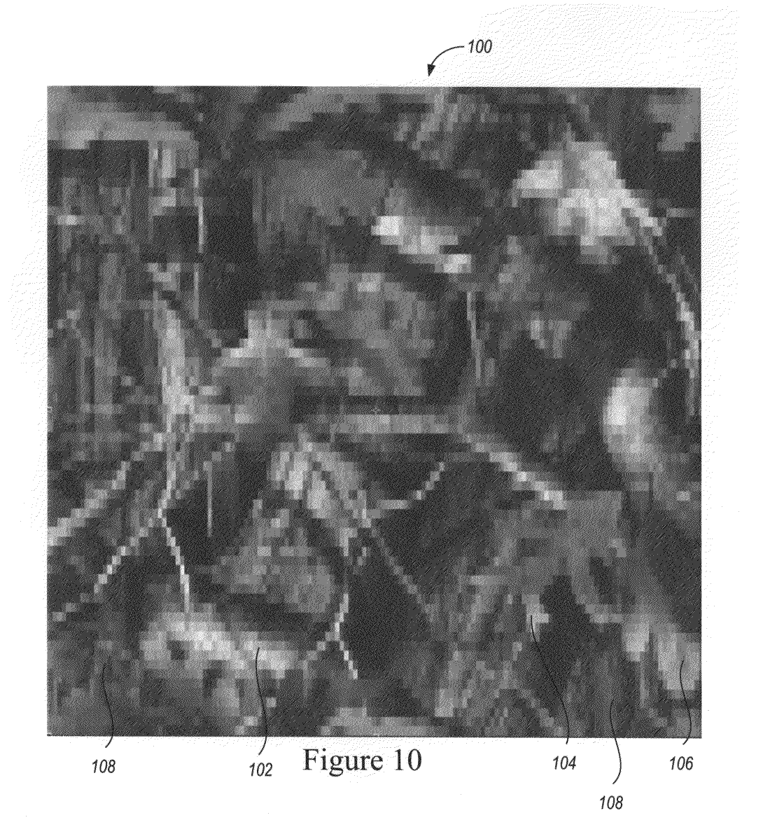

FIG. 9 illustrates a pattern 90 that will be used as a background to the larger shapes of the pattern 80 in the exemplary embodiment creating a camouflage pattern begun in FIG. 4. In this example, the background pattern 90 is derived from an image of a tree.

FIG. 10 illustrates the camouflage pattern 100 created by the exemplary embodiment creating a camouflage pattern begun in FIG. 4. The camouflage pattern 100 includes larger shapes such as shapes 102, 104, 106 that will appear distinct when viewed from a distance such as 10 yards. The pattern 100 also includes background 108. The pattern 100 can be put on various types of articles. The pattern can be designed for use at a designed size. For example, the pattern 100 may be designed to appear 25 inches×25 inches and then repeat.

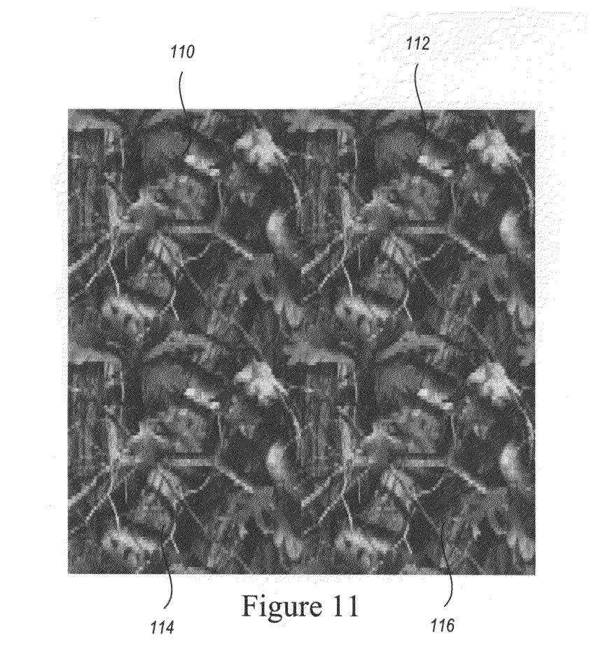

FIG. 11 shows four abutting instances 110, 112, 114, 116 of the camouflage pattern 100 of FIG. 10. The pattern 100 is continuous with respect to repeating in the sense that it can be stacked side to side and one on top of the other and larger shapes will abut one another at the edges.

Once a pattern has been created, it can be provided for use on an article of manufacture in a variety of ways. For example, an image of the pattern 100 can be exported (e.g., in Tiff format) for engraving rotor development.

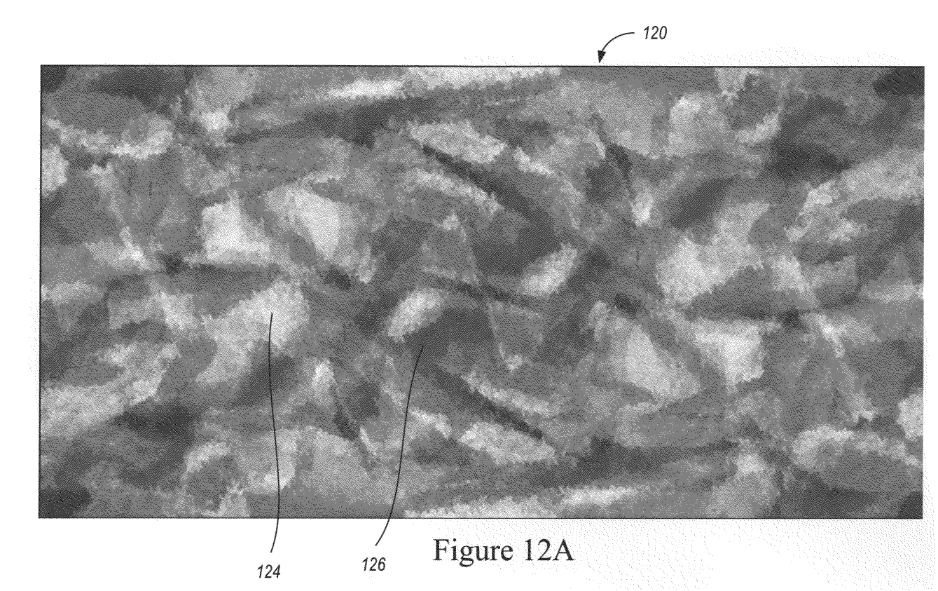

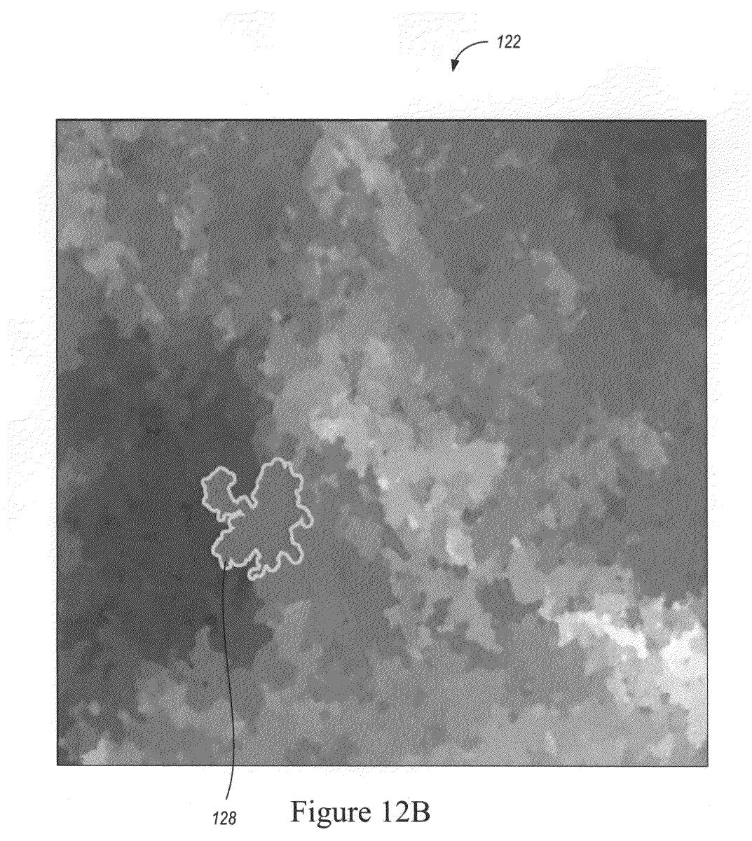

FIGS. 12A-B illustrate another exemplary pattern 120 according to certain embodiments. FIG. 12A shows the full pattern and FIG. 12B shows a close up of a portion 122 of the exemplary pattern 120. In this exemplary pattern 120, single-color shapes are used to form larger shapes, such as larger shapes 124 and 126. The shape of the individual single-color shapes, in many cases, is variable and organic. For example, single-color shape 128 shown in FIG. 12B has an organic shape.

These embodiments are mentioned to provide examples and aid understanding. Additional embodiments and advantages will be readily apparent to those skilled in the art. As will be realized, the invention is capable of other and different embodiments, and its several details and steps are not essential, but rather are capable of modifications in various respects. For example, it will be recognized that a variety of different patterns can be created using less than all of the techniques described herein. Accordingly, the description, as well as the drawings, are to be regarded as illustrative in nature, and not as restrictive.

What is claimed is:

1. An article of manufacture comprising:
a surface with a pattern comprising single-color shapes; and
larger shapes formed by groupings of the single-color shapes, at least some of the larger shapes each comprising a grouping of single-color shapes having a sufficient size and shape and at least partially bordered by single-color shapes of one or more other colors of sufficient color difference from the single-color shapes in the grouping such that the larger shape appears distinct when viewed at a distance of 10 yards.

2. The article of claim 1, wherein:
each single-color shape has a color derived from a portion of a photograph or other image of natural elements; and
the pattern mimics the natural elements and camouflages the article when the article is used in a natural environment that includes similar natural elements.

3. The article of claim 2, wherein the pattern appears a blurred mosaic of the natural elements when viewed at a distance of less than 3 yards and wherein the natural elements appear distinct and do not blob out when viewed at a distance of 10 yards, wherein “do not blob out” means that the pattern as a whole does not appear to have a single-color or repeating pattern such that the single-color or repeating pattern betrays the shape of the article when the article is used in a natural environment that includes similar natural elements.

4. The article of claim 1, wherein at least some of the larger shapes appear distinct when viewed at a distance of 30 yards.

5. The article of claim 1, wherein at least some of the larger shapes appear distinct when viewed at a distance of 50 yards.

6. The article of claim 1, wherein at least some of the larger shapes appear distinct when viewed at a distance of 100 yards.

7. An article of manufacture comprising:
a surface with a camouflage pattern comprising single-color shapes; and
larger shapes formed by groupings of the single-color shapes, wherein at least some of the larger shapes portray natural elements, wherein a larger shape portraying a natural element comprises a limited number of colors, wherein the limited number of colors is less than the number of colors in the natural element that is portrayed by the larger shape.

8. The article of claim 7, wherein at least some of the single-color shapes are sized so that the camouflage pattern appears to be a blurred mosaic of natural elements at a distance of 3 yards but projects to appear as a collection of the larger shapes, distinct from one another, at a distance of 10 yards.

9. The article of claim 7, wherein:
the larger shape portraying a natural element is derived from a portion of a photograph or other image of the natural element, wherein the natural element is a leaf, tree branch, tree trunk, or other tree portion; and
the article is a jacket, shirt, pants, hat, socks, bandana, gun, tent, vehicle, aircraft, watercraft, or building.

10. The article of claim 7, wherein:
the limited number of colors of the larger shape is 5 colors or fewer;
all of the 5 colors or fewer are neutral colors; and
at least some of the single-color shapes are either elongated vertically or are square.

11. The article of claim 7, wherein the limited number of colors of the larger shape is 3 colors or fewer.

12. The article of claim 7, wherein the limited number of colors of the larger shape is a single color.

13. A method of providing a camouflage pattern on an article of manufacture, the method comprising:
positioning one or more larger shapes in a pattern area, at least some of the one or more larger shapes portraying natural elements;
modifying the appearance of the one or more larger shapes, wherein the one or more larger shapes are modified to appear as groupings of single-color shapes wherein the single-color shapes are configured such that when the pattern is used on an article of manufacture at least some of the one or more larger shapes will appear distinct when viewed at a distance of 10 yards; and
providing the camouflage pattern for use on the article of manufacture.

14. The method of claim 13 further comprising configuring the single-color shapes to have a sufficient size and shape such that at least some of the one or more larger shapes will appear distinct when viewed at a distance of 10 yards.

15. The method of claim 13 further comprising configuring the camouflage pattern so that at least some of the groupings of single-color shapes forming at least some of the larger shapes are at least partially bordered by single-color shapes of one or more other colors of sufficient color difference such that at least some of the one or more larger shapes will appears distinct when viewed at a distance of 10 yards.

16. The method of claim 13 further comprising configuring the camouflage pattern so that a larger shape portraying a natural element comprises a grouping of single color shapes of a limited number of colors, wherein the limited number of colors is less than the number of colors in the natural element that is portrayed by the larger shape.

17. The method of claim 13, wherein at least some of the single-color shapes are sized so that the camouflage pattern appears to be a blurred mosaic of natural elements at a distance of 3 yards but projects to appear as a collection of the larger shapes, distinct from one another, at a distance of 10 yards.

18. The method of claim 13 further comprising using the article of manufacture in a natural environment in which the camouflage pattern camouflages the article.

19. The method of claim 13, wherein the at least some of the larger shapes portraying natural elements are derived from portions of one or more photographs or other images of the natural elements.

20. The method of claim 13 further comprising:
positioning larger shapes on different layers of an electronic document comprising the camouflage pattern;
using a background layer of the different layers of the document to provide a portion of the pattern that will appear less distinct than at least some of the larger shapes; and
combining the different layers of the document into a single layer prior to modifying the appearance of the one or more larger shapes.

21. The method of claim 13 further comprising:
modifying one or more dimensions of the camouflage pattern prior to modifying the appearance of the one or more larger shapes; and
restoring the dimension of the pattern after modifying the appearance of the one or more larger shapes;
wherein restoring the dimensions results in changing dimensions of the single-color shapes that form the larger shapes, wherein restoring the dimensions results in vertically elongated single-color shapes.

22. The method of claim 13, wherein the single-color shapes are configured to have a brick, hexagon, square, triangle, or organically-shaped shape.

23. The method of claim 13, wherein the single-color shapes are configured to each have a shape formed by a shape boundary, wherein the shape of the single-color shapes varies among the single-color shapes.

24. The method of claim 13 further comprising reducing a number of colors in the camouflage pattern to modify the pattern for an engraving used to provide the pattern on the article of manufacture.

25. The method of claim 13 further comprising configuring the single-color shapes such that when the pattern is used on the article at least some of the one or more larger shapes will appear distinct when viewed at a distance of 10 yards by viewing the pattern displayed on a computing device from a distance of more than a 5 feet and making a determination of whether to adjust the size or shape of single-color pixels.

26. The method of claim 13 further comprising providing the camouflage pattern for use on the article, wherein the scale of the pattern is such that the larger shapes portraying natural elements are approximately equal in size to the natural elements that are portrayed.

27. The method of claim 13 further comprising providing the camouflage pattern for use on the article, wherein the scale of the pattern is such that the larger shapes portraying natural elements are between 5% and 15% larger in size than the natural elements portrayed by the larger shapes.

28. The method of claim 13, wherein the camouflage pattern is repeated on the article, wherein at least some of the larger shapes connect to corresponding larger shapes at the boundary of a first instance of the pattern and a second instance of the pattern.
